(19) United States
(12) Patent Application Publication
(10) Pub. No.: US 2018/0242438 A1
(43) Pub. Date: Aug. 23, 2018

(54) GROUND ROLLER ASSEMBLY

(71) Applicant: MacLean Power, L.L.C., Fort Mill, SC (US)

(72) Inventors: Wei-Chung Lin, Birmingham, AL (US); Maxwell Goldsmith, Birmingham, AL (US)

(73) Assignee: MacLean Power, L.L.C., Fort Mill, SC (US)

(21) Appl. No.: 15/885,185

(22) Filed: Jan. 31, 2018

Related U.S. Application Data
(60) Provisional application No. 62/460,443, filed on Feb. 17, 2017.

(51) Int. Cl. H05F 3/02; H02G 1/04; H01R 4/64

(52) U.S. Cl. CPC H05F 3/02; H01R 4/646; H02G 1/04

(57) ABSTRACT

The present disclosure provides a ground roller assembly for grounding electrical current induced in a conductor during installation of high power transmission lines. The ground roller assembly may include a mounting bracket having a plurality of pivot points spaced away from a mounting aperture, and an integrally formed tongue projecting outwardly away from an upper edge of the mounting bracket. A support arm may be coupled to one of the plurality of pivot points positioned proximate to a side edge of the mounting bracket. A sheave configured to receive an electrical conductor may be attached to an end of the support arm opposite the mounting bracket

### CROSS-REFERENCE TO RELATED APPLICATION

The present patent document claims the benefit of the filing date under 35 U.S.C. § 119(e) of Provisional U.S. Patent Application Ser. No. 62/460,443, filed Feb. 17, 2017, which is hereby incorporated by reference.

### BACKGROUND

During the installation process of high voltage transmission power lines, single or multiple conductors are strung between transmission towers. Stringing blocks may be suspended in the air from the transmission tower with the conductors running through the stringing block to aid in the installation process. In some instances, as the conductor is pulled through the stringing block static electricity is induced in the conductor because of the friction of the conductor against the stringing block. In other situations, the proximity to other live power lines or lightening can cause the induction of electricity in the new conductors during the installation process. These inducted electrical charges can be quite dangerous, and sometimes deadly, to the workers that are performing the installation. To safeguard against these dangers, ground roller assemblies can be connected to the stringing block. The ground roller assemblies can provide a constant ground while not interfering with the rotation of the stringing block while the conductor is pulled.

One disadvantage of currently-known ground roller assembly hardware is that a pivoting support arm that provides grounding for the pulled conductor mounts to the same location that the ground roller assembly mounts to the stringing block. Thus, as force is placed on the pivoting support arm, it can cause the mounting hardware to loosen and may limit the ground roller assemblies' effectiveness. Another disadvantage of the currently-known hardware is the size and amount of hardware need to mount the ground roller assembly to a stringing block. For example, in some currently-known assemblies, multiple pivoting support arms are required and are positioned to astride the stringing block, or additional hardware is required to limit rotation of the support arms. This results in high production costs, and increased points of potential failure. As such, and improved ground rolling assembly, and ground rolling assembly mounting bracket are needed.

### BRIEF SUMMARY

In one aspect, the present disclosure provides a ground roller assembly for grounding electrical current induced in a conductor during installation of high power transmission lines. The ground roller assembly may include a mounting bracket having a plurality of pivot points spaced away from a mounting aperture, and an integrally formed tongue projecting outwardly away from an upper edge of the mounting bracket. A support arm may be coupled to one of the plurality of pivot points positioned proximate to a side edge of the mounting bracket. A sheave configured to receive an electrical conductor may be attached to an end of the support arm opposite the mounting bracket.

In another aspect, the present disclosure provides for a ground roller assembly mounting bracket configured to support a sheave from a single side of a stringing block. The mounting bracket includes a first side and a second side. A mounting aperture extends through the first side and the second side of the mounting bracket. A first pivot aperture that extends through the first side and the second side, and positioned proximate to a first side edge of the bracket and spaced apart from the mounting aperture. A tongue positioned along an upper edge of the bracket and that projects perpendicularly away from the second side of the bracket, where the tongue is integrally formed with the bracket and configured to be received by a channel in a stringing block frame.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

FIG. 1 shows a front view of grounding system that includes a stringing block, a stringing block frame, and a ground roller assembly including a ground roller assembly mounting bracket.

FIG. 2 shows a partial top plan view of the grounding system of FIG. 1.

FIG. 3 shows a first perspective view of a ground roller assembly.

FIG. 4 shows a second perspective view of a ground roller assembly along line 4-4 of FIG. 1.

FIG. 5 shows a first side view of a ground roller assembly mounting bracket.

FIG. 6 shows a second side view of a ground roller assembly mounting bracket.

FIG. 7 shows a first perspective view of a ground roller assembly mounting bracket.

FIG. 8 shows a second perspective view of a ground roller assembly mounting bracket.

### DETAILED DESCRIPTION

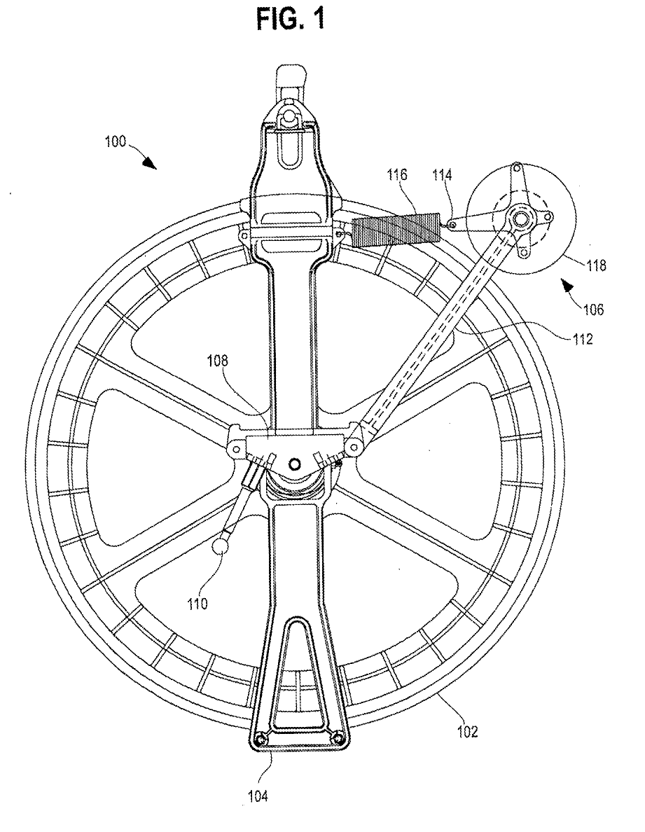

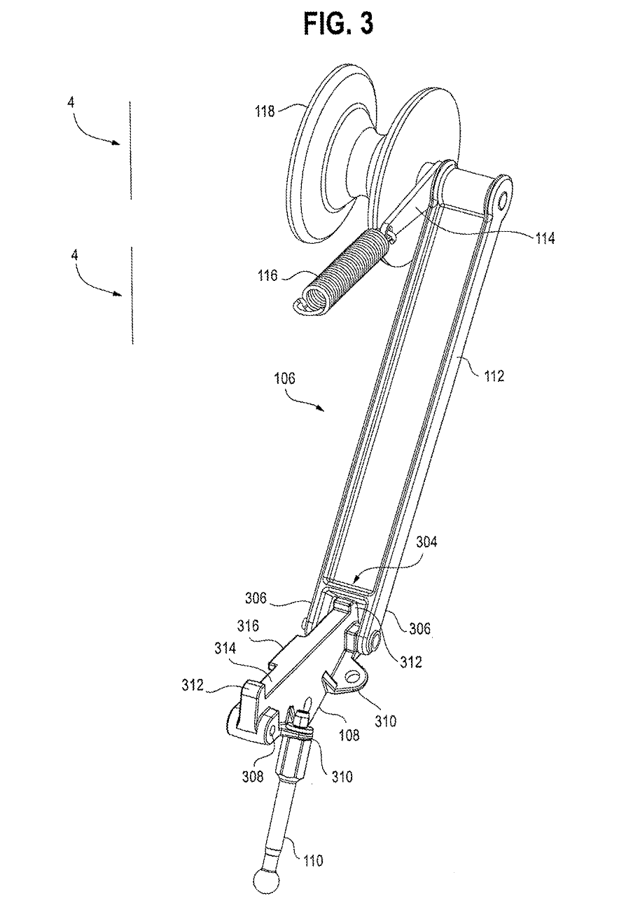

FIG. 1 shows a front view of a grounding system 100. The grounding system 100 includes a traditional stringing block 102 and stringing block frame 104, and an improved ground roller assembly that is generally depicted as 106. The ground roller assembly 106 attaches to a single side of stringing block frame 104 by a ground roller assembly mounting bracket 108 through use of a fastener, such as a bolt or other mounting pin. A tongue (see FIGS. 3-4, 6-8) formed in the side of the ground roller assembly mounting bracket 108 may mate with a channel in the stringing block frame 104 to stabilize and substantially prevent rotation of the ground roller assembly mounting bracket 108 when a conductor applies a force to the ground roller assembly 106. A grounding pin 110 may be mounted to the ground roller assembly mounting bracket 108 which may be connected to a grounding wire (not shown) for grounding any electrical charge that may build up in the grounding system 100.

Pivotally mounted proximate to a side edge of the ground roller assembly mounting bracket 108 is support arm 112. Support arm 112 may be substantially I-shaped with a top and a bottom side stiffener. A central portion of the support arm 112 may be generally perpendicular to the top and bottom stiffeners and may be connect integrally or through another attachment mechanism, such as welding, fusion, or the like to the top and bottom stiffeners. The central portion of the support arm 112 may be positioned approximately at the center of each stiffener. The general I-shape of the support arm 112 may aid in distributing force that is applied to the support arm 112 by way of the sheave 118, the biasing spring 116, and the weight of an electrical conductor that is run over sheave 118. Support arm 112 may include legs (see FIG. 3) 306 that extend beyond a cross-member 304 such that the legs 306 of the support arm 112 astride the side edge of the ground roller assembly mounting bracket 108, and enable the support arm 112 to be mounted to the ground roller assembly mounting bracket with a pivoting pin. The distal end of the support may include a spring mounting member 114 that connects a biasing spring 116 to the stringing block frame 104. Also mounted to the distal end of the support arm 112 is a sheave 118 over which a conductor (not shown) is run. The weight of the conductor on the sheave 118 causes a downward force on support arm 112, while the biasing spring 116 may provide upward force on the support arm 112. These opposing forces on the support arm 112 cause a contact surface on the inner portion of sheave 118 to contact an underside of the conductor resting thereon. Different conductors will have different weights, and thus the different conductors will apply different downward forces. The amount of pivoting of the support arm 112 about the pivot aperture point will therefore depend on the downward force applied by a conductor and the upward bias of biasing spring 116. The structural and hardware elements of the ground roller assembly 106 may be formed from electrical conductive material, such that any electrical charge induced in a conductor running over sheave 118, may flow through the ground roller assembly structure and hardware to the grounding pin 110, and ultimately to ground. In some configurations, mounting bracket 108, support arm 112, and sheave 118 may be made of material that provides at least mechanical strength, hardness, fatigue strength, and electrical conductivity. This material could be an aluminum alloy that possesses these qualities. Some of these materials could be aluminum alloy A356T6 or 6061 aluminum, and the parts could be made in accordance with a sand casting or molding technique. In some other configuration the mounting bracket 108, support arm 112, and sheave 118 could be made from a different alloy that is mold or die casted, or made of a cast iron or cast steel material.

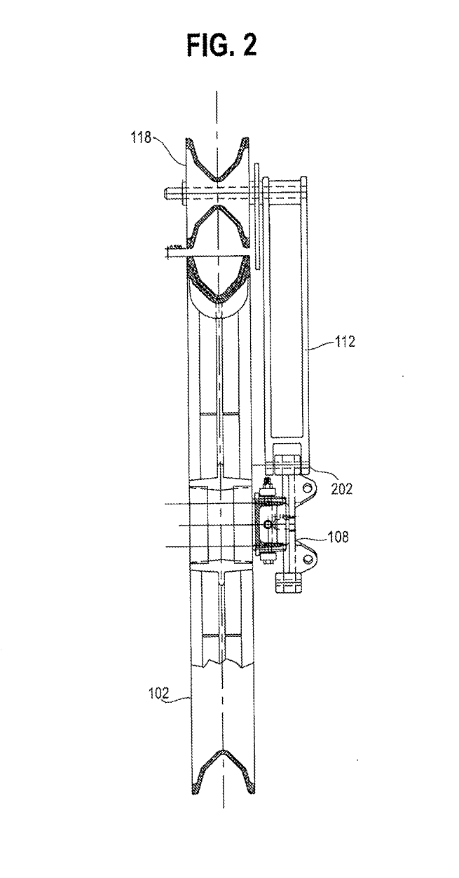

Referring to FIG. 2, it can be seen that the end of the support arm 112 that is proximate to the ground roller assembly mounting bracket 108 astride the bracket 108 at a side edge such that the bracket includes a pivot aperture through which a pivot pin 202 can be placed to secure the supporting arm 112 to the ground roller assembly mounting bracket 108.

FIG. 3 is a first perspective view of the ground roller assembly 106. As shown in FIG. 3, a pin or other securing mechanism may be used to attach the sheave 118 and spring mounting member to the support arm 112. At the opposite end of the support arm 112 is a support arm cross-member 304. The support arm cross-member 304 together with support arm legs 306 form a generally upside down U-shaped opening such that the support arm 112 can be mounted astride the ground roller assembly mounting bracket 108. Proximate both sides edges of the ground roller assembly mounting bracket are pivot apertures 308 (only one shown in FIG. 3 because the support arm 112 is connected through the other pivot aperture) these pivot apertures 308 extend through from a first side of the ground roller assembly mounting bracket 108 to a second side of the ground roller assembly mounting bracket 108.

As also shown in FIG. 3, the ground roller assembly mounting bracket 108 includes two ground pin supports 310. Together with the pivot apertures 308 and the ground pin supports 310, the ground roller assembly mounting bracket 108 may be used in reversible fashion. More specifically, if it was desired to connect the support arm 112 to the pivot aperture 308 shown on the left in FIG. 3, the grounding pin 110 could be connected to the ground pin support 310 shown on the right in FIG. 3. Ground pin supports 310 may be used to connect a grounding pin 110 to the ground roller assembly mounting bracket 108. As shown, the ground pin supports 310 extend away from the ground roller assembly mounting bracket 108 in a perpendicular manner, although it is envisioned that they could extend away from the ground roller assembly mounting bracket 108 at other angles as well. The ground pin supports 310 may be angled with respect to a horizontal plane of the ground roller assembly mounting bracket 108 to aid in connecting the grounding pin to a ground wire (not shown) that is free from interfering with the string block 102.

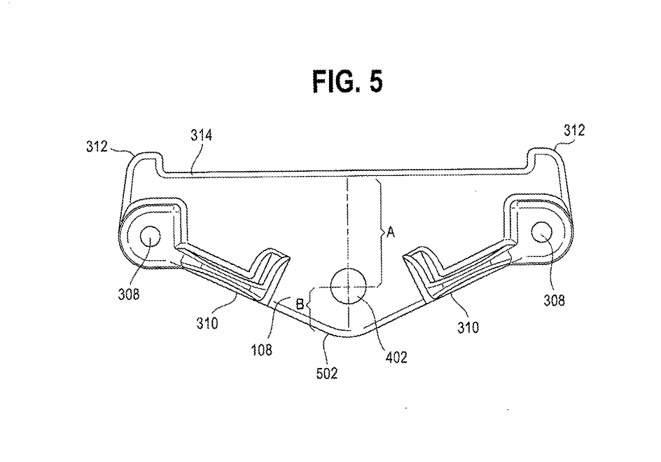

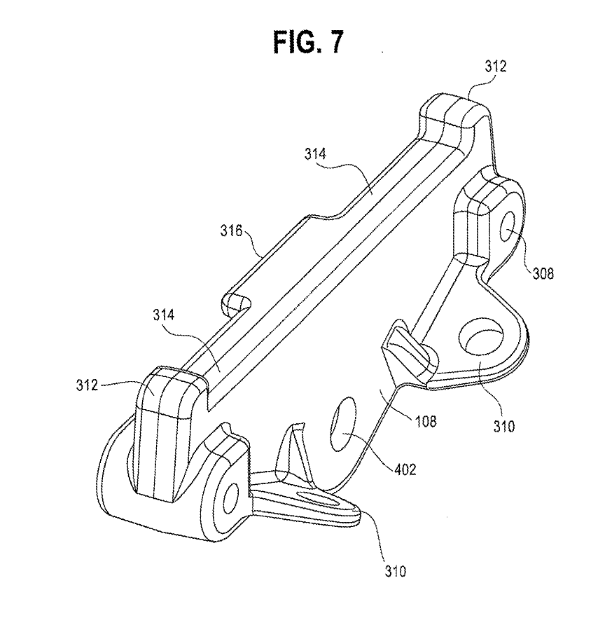

As shown in FIG. 3 (as well as FIGS. 5 and 7), ground pin supports 310 are formed as (or attached to) the ground roller assembly mounting bracket 108. Accordingly, as support arm 112 pivots downward as a result of the weight of a conductor on sheave 118, or upward as a result of the biasing spring 116 and the absence of the weight of a conductor on sheave 118, the ground pin supports 310 and likewise the ground pin 110, remain in a fixed location with respect to the ground roller assembly mounting bracket 108. Limiting the movement of the ground pin 110 in turn may limit the stress on the connection point of the ground wire and ground pin 110. This has the advantage of the ground wire becoming disconnected which can result in harm to the workers performing the installation as well as reducing downtime for the need to reconnect the ground wire to the ground pin 110.

As further shown in FIG. 3, support arm stops 312 may extend upwardly away from an upper surface 314 of the ground roller assembly mounting bracket 108. The support arm stops 312 may be dimensioned such that the outward surface of the support arm stop 312 limits the amount of pivot (or rotation) of the support arm 112 forward under the bias of spring 116 when there is no downward force from a conductor on sheave 118. Thus, the amount of forward pivot (or rotation) of the support arm 112 when a conductor is not run over sheave 118 can be limited by the support arm stop 312 and the support arm cross-member 304 without the need for additional hardware, such as a brake, bolt, additional tension spring, and the like. In some configurations, the outer surface of the support arm stops 312 may have a rounded or curved surface. However, in other configurations the outer surface of the support arms 312 may have more of a generally abrupt corner.

To aid the ground roller assembly mounting bracket 108 from rotating when it is mounted to the stringing block frame 104, a tongue 316 is formed in an edge of the upper surface 314 of the ground roller assembly mounting bracket 108. The tongue 316 may be dimensioned such that it is received in a channel of the stringing block frame 104. When installed in the channel, if the ground roller assembly mounting bracket 108 attempted to rotate, the tongue 316 would contact the sides of the stringing block frame's channel and act as a wedge, thus limiting and/or preventing rotation.

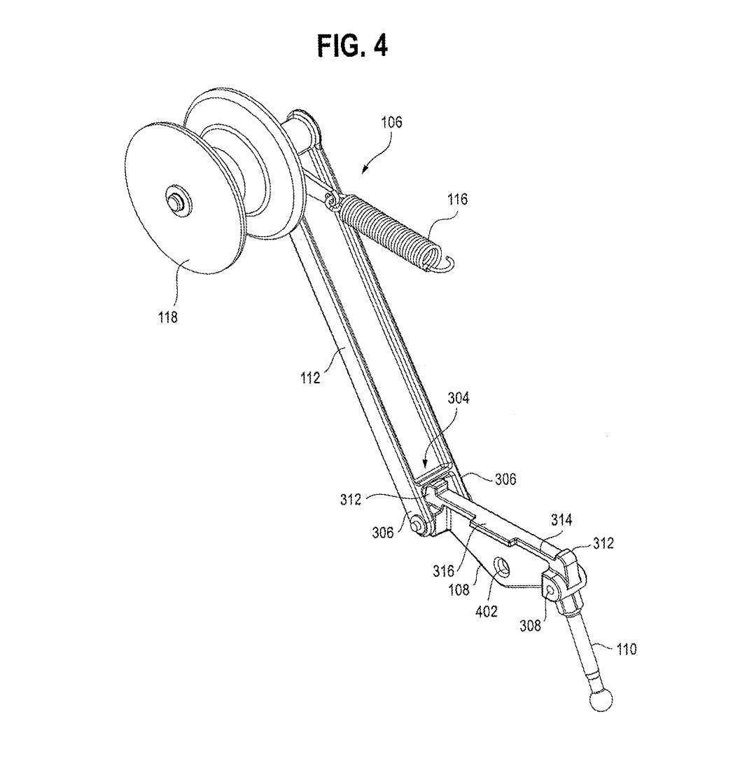

FIG. 4 is a second perspective view of ground roller assembly 106 looking along line 4-4 of FIG. 3. As shown in FIG. 4, a mounting aperture 402 may be located proximate to a bottom edge of the ground roller assembly mounting bracket 108 and centrally located along the length of the ground roller assembly mounting bracket 108. The mounting aperture 402 may extend through both sides of the ground roller assembly mounting bracket 108, so that a securing mechanism, such as a bolt, screw, rivet, or the like can be used to rigidly mount the ground roller assembly mounting bracket 108 to a stringing block frame 104.

FIG. 5 is a first side view of the ground roller assembly mounting bracket 108. As shown in FIG. 5, both pivot apertures 308 are illustrated, each being proximate to a different side edge of the ground roller assembly mounting bracket 108. As shown in FIG. 5, mounting aperture 402 is spaced away from each of the pivot apertures 308. Thus, when the ground roller assembly mounting bracket 108 is mounted to a stringing block frame 104, the point of pivot (or rotation) of the support arm 112 will be spaced apart from the primary location (for example, the mounting aperture 402) that the ground roller assembly mounting bracket 108 is attached to the stringing block frame 104. In FIG. 5, the bottom edge 502 of the ground roller assembly mounting bracket 108 has a generally concave curvature and resembles an expanded U-Shape. The ground pin supports 310 are angled to align with the bottom edge 502 of the ground roller assembly mounting bracket 108 to aid in the attachment of the grounding pin and grounding wire without interference to the stringing block 108.

As shown in FIG. 5 the mounting aperture 402 may be positioned such that a vertical distance “A” (illustrated by a first dashed line in FIG. 5) between the center of the mounting aperture 402 and the upper surface 314 of the ground roller assembly mounting bracket is greater than the vertical distance “B” (illustrated by a second dashed line in FIG. 5) between the center of the mounting aperture 402 and a bottom edge 502 of the ground roller assembly mounting bracket. It is envisioned that the mounting aperture 402 could be positioned elsewhere within the ground roller assembly mounting bracket 108. For example, mounting aperture 402, could be positioned in-line with the plurality of pivot apertures 308, or such that the vertical distance between the center of the mounting aperture 402 and the upper surface 314 of the ground roller assembly mounting bracket is less than the vertical distance between the center of the mounting aperture 402 and a bottom edge 502 of the ground roller assembly mounting bracket.

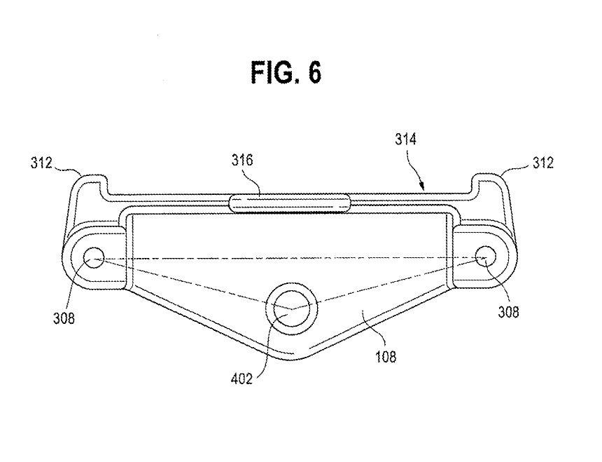

FIG. 6 is a second side view of the ground roller assembly mounting bracket 108. Centrally located along an upper surface of the ground roller assembly mounting bracket 108 is tongue 316. Tongue 316 may be integrally formed with the ground roller assembly mounting bracket 108 to increase the strength of the tongue 316 and the ground roller assembly mounting bracket 108. FIGS. 6 also illustrates by way of dashed lines that the plurality of pivot apertures 308 and the mounting aperture 402 may be positioned such that lines extending from and connecting the centers of each of these apertures would form a triangle. In some configurations, the triangle formed by connecting the centers of the apertures can be an isosceles triangle, with the distances between each of the pivot apparatus 308 and the mounting aperture 402 being approximately equal.

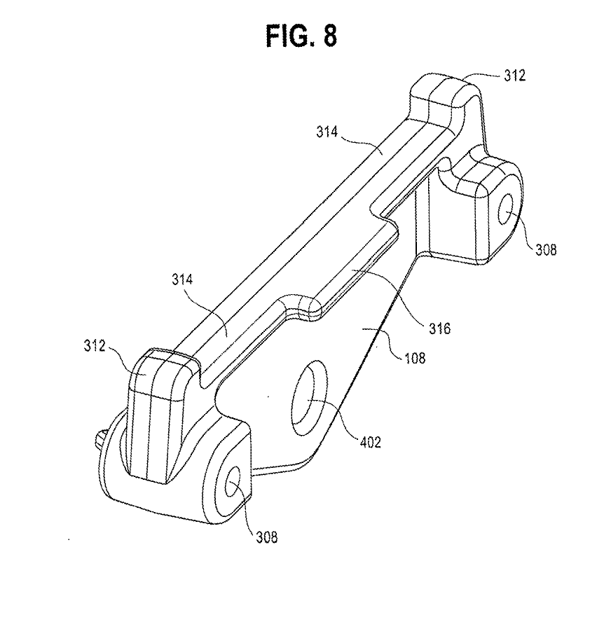

FIG. 7 is a first perspective view of the ground roller assembly mounting bracket 108. FIG. 8 is a second perspective view of the ground roller assembly mounting bracket 108. As shown in at least FIGS. 5-8, the tongue 316 may be centrally positioned along the edge of upper surface 314 of the ground roller assembly mounting bracket 108. To further aid in stabilizing the ground roller assembly mounting bracket 108 when it is coupled with stringing block frame 104, tongue 316 may also be horizontally centered with the center of mounting aperture 402.

As used during installation of an electrical conductor, an electrical conductor may be run over the stringing block 102 wheel, and then over sheave 118. As the electrical conductor is pulled away from the grounding system 100 (e.g. away from sheave 118 and towards the right hand side of FIG. 1), the weight of the electrical conductor on sheave 118 will apply a downward force on sheave 118 and support arm 112. As a result, support arm 112 will pivot an amount downwards (e.g. clockwise). Bias spring 116 limits the downward amount of pivot of support arm 112 such that sheave 112 will not contact stringing block 102. If during the time that the electrical conductor is not held tightly in position, the downward force applied to the sheave 118 and the support arm 112 may change. In such a situation, the support arm 112 may pivot upwards (e.g., counterclockwise) as a result of more upward force being applied by spring 116 than downward force applied by way of the weight of the electrical conductor. Support arm stop 312 may limit the upward pivot of support arm 112 when the support arm 112 contacts the outer surface of support arm stop 312. In such a situation, no additional hardware other than the support arm stop 312 on ground roller assembly mounting bracket 108 and the support arm 112 is needed to limit the amount of upward pivot of the support arm 112. Similarly, when no electrical conductor is being run through the ground system 100, such as before or after the installation process, support arm stop 312 limits the upward pivot of support arm 112.

The embodiments of the ground roller assembly described herein may be advantageous at least for ensure a more securely fastened ground roller assembly which may reduce technician exposure to dangerous conditions during the installation of high power transmission lines. The described ground roller assembly mounting bracket additionally separates the pivot point of the support arm from the main mounting point of the ground roller assembly mounting bracket to a stringing block frame. Thus, reducing the amount of hardware and production costs for the described system. These embodiments may also provide simple, efficient, and reversible installation of a ground roller assembly.

With respect to the embodiments described herein, it will be understood by those skilled in the art that various changes in form and details may be made therein without departing from the spirit and scope of the invention as defined by the following claims.

1. A ground roller assembly, comprising:
a mounting bracket having a plurality of pivot points spaced away from a mounting aperture, and an integrally formed tongue projecting outwardly away from an upper edge of the mounting bracket;
a support arm coupled to one of the plurality of pivot points positioned proximate a side edge of the mounting bracket; and
a sheave coupled to an end of the support arm that is opposite from the side edge of the mounting bracket, where the sheave is configured to receive an electrical conductor.

2. The ground roller assembly of claim 1, further comprising a plurality of grounding pin supports positioned on an opposite side of the mounting bracket from the tongue.

3. The ground roller assembly of claim 1, further comprising a plurality of support arm stops projecting upwardly from an upper surface of the mounting bracket, where the upper surface of the mounting bracket and a surface of the plurality of support arm stops form a generally U-shaped surface.

4. The ground roller assembly of claim 1, further comprising a plurality of support arm stops positioned at outer side edges of the mounting bracket.

5. The ground roller assembly of claim 4, where an outer surface of each of the plurality of support arms comprises a rounded surface.

6. A ground roller assembly mounting bracket configured to support a sheave from a single side of a stringing block, comprising:
a first side and a second side;
a mounting aperture that extends through the first side and the second side;
a first pivot aperture that extends through the first side and the second side, and positioned proximate to a first side edge of the bracket and spaced apart from the mounting aperture; and
a tongue positioned along an upper edge of the ground roller assembly mounting bracket and that projects perpendicularly away from the second side of the ground roller assembly mounting bracket, where the tongue is integrally formed with the ground roller assembly mounting bracket and configured to be received by a channel in a stringing block frame.

7. The ground roller assembly mounting bracket of claim 6, where the first side edge projects above an upper surface of the ground roller assembly mounting bracket.

8. The ground roller assembly mounting bracket of claim 6, further comprising a second pivot aperture positioned proximate to a second side edge of the ground roller assembly mounting bracket, and where the second pivot aperture is spaced apart from the first pivot aperture and the mounting aperture.

9. The ground roller assembly mounting bracket of claim 8, where lines extending from and connecting a center of each of the first pivot aperture, the second pivot aperture, and the mounting aperture form a triangle.

10. The ground roller assembly mounting bracket of claim 9, where the triangle is an isosceles triangle.

11. The ground roller assembly mounting bracket of claim 8, where a distance between a center of the first pivot aperture and a center of the mounting aperture is approximately equal to a distance between a center of the second pivot aperture and the center of the mounting aperture.

12. The ground roller assembly mounting bracket of claim 1, where the tongue is centrally positioned along the upper edge of the ground roller assembly mounting bracket.

13. The ground roller assembly mounting bracket of claim 1, where the tongue is positioned above the mounting aperture.

14. The ground roller assembly mounting bracket of claim 12, where a center of the tongue is aligned with a center of the mounting aperture.

15. The ground roller assembly mounting bracket of claim 1, where a vertical distance between a center of the mounting aperture and an upper surface of the ground assembly mounting bracket is greater than a vertical distance between a center of the mounting aperture and a lower edge of the ground roller assembly mounting bracket.

16. A ground roller assembly mounting bracket configured to support a sheave from a single side of a stringing block, comprising:
a first side and a second side; and
a first pivot aperture that extends through the first side and the second side, and positioned proximate to a first side edge of the bracket,
where the first side edge of the bracket extends upward above an upper surface of the bracket and is configured to directly limit an amount of counterclockwise pivot of a support arm mounted to the bracket at the first pivot aperture.
